(19) United States
(12) Patent Application Publication
(10) Pub. No.: US 2018/0083958 A1
(43) Pub. Date: Mar. 22, 2018

(54) SYSTEM AND METHOD FOR NETWORK USER'S AUTHENTICATION AND REGISTRATION BY WAY OF THIRD PARTY COMPUTING DEVICE

(71) Applicants: Dmitriy Avilov, Moscow (RU); Maxim Avilov, Moscow (RU)

(72) Inventors: Dmitriy Avilov, Moscow (RU); Maxim Avilov, Moscow (RU)

(21) Appl. No.: 15/268,609

(22) Filed: Sep. 18, 2016

(51) Int. Cl. H04L 29/06; G06K 7/14

(52) U.S. Cl. CPC H04L 63/0853; H04L 63/083; G06K 7/1413; H04L 63/1466; H04L 63/10

(57) ABSTRACT

The present invention concerns generally with a system and method for computer users' registration and authentication using a third-party computing device. The third-party device temporarily assumes the identify of a less secured client computer for the period necessary for the client's authentication or registration.

This application claims the benefit of U.S. Provisional Application No. 62/221,074, filed Sep. 20, 2015.

### FIELD OF THE INVENTION

The present invention is in the technical field of human-computer interactions, and, more particularly, in the field of computer users' authentication. Specifically, the present invention offers a system and method for computer users' registration and authentication using a third-party computing device.

### BACKGROUND OF THE INVENTION

Typically, the most common approach to a computer network user′ authentication and registration involves a two-way communication between the user (a person), the computing device functioning in the capacity of a client (hereinafter “client”: a personal computer, a laptop, a tablet computer, or a smartphone), and the computing device functioning in the capacity of a server (hereinafter “server”: a remote computer, a secured website, an FTP site, etc.). When an unregistered user logs onto a client and then attempts to connect to a remote server that requires the user to be authenticated prior to be allowed access to the server's protected resources, such as applications, databases, etc., the user must first be registered, e.g. have an authenticating record comprising a combination of the user's login name (the “user ID”) and her password (the “password”). In some cases, the foregoing registration can be done by the user herself, while in other cases it can be done by the server's administrator who, in a likewise manner, creates a record accessible to the server comprising the user ID and the password. Once the user is registered, she can get access to the server's protected resources by establishing a network connection from the client to the server, and then providing the server with the combination of her user ID and the password. That combination gets matched against the user's authenticating record accessible to the server; if the match is found the user is deemed authenticated and is permitted to access the server's protected resources. If the match is not found, however, the user is barred from accessing those resources.

The foregoing approach utilizes a classical algorithm inherited from the pre-computer era, where a person seeking access to a specific protected site had to be first identified by his name (“user ID”), and then by the secret word (“password”) known only to the people authorized accessing that protected site and the guards protecting it. Like in the foregoing client-server authentication scenario, the person, prior to accessing the controlled site, had to “register”, or share her identity with the guards, then learn the password, and only then the guards could authenticate that person and allow her to access the site.

Similarly, a user seeking access to a server, which could be a remote server, a protected website, etc., must first be registered by creating a record accessible to the server and comprising the combination of the user ID and the password. To do that in the Internet setting, the user typically opens a browser, types the address of the protected site, selects an option to register, answers a set of questions, selects a unique user ID (the authenticating service running on that protected site would flag an error if the user ID selected was not unique), chooses a password (similarly, an error would result if the password chosen was weak or otherwise in violation of the established security policy), and completes her registration by saving the information entered.

The foregoing user ID and password combination (the “authenticating data”), as well the information pertinent to password recovery options, such as control questions, telephone numbers, etc., must be safeguarded by the user because any act of misappropriation of that authenticating data may cause an irreparable damage to the user and lead to the user's identity theft, dissemination of her personal and financial data, damaging user's reputation and endangering her wellbeing.

Safeguarding authenticating data is not a trivial task considering that a typical Internet user needs to preserve and protect authenticating data related to a variety of websites and remote resources that may have different user authentication policies, password change frequencies, registration data retention periods, and so on, in which case the user would either tend to use the same combination of the user ID and password for all remote sites, which could be extremely consequential if authenticating data is disseminated, or attempt to remember multiple combinations of user IDs and passwords, which is a difficult task on its own. Sometimes, the user may wish to employ a system for storing user IDs and passwords, which could be either based on a note (the “note approach”), where authenticating data is preserved in a conventional notebook, on a sticky note, or in an unencrypted electronic file, or it can be done through a vault-type software application (the “vault approach”), where authenticating data is written into the “vault” encrypted and protected by a strong master password.

The note approach is inherently dangerous, since if the note containing the user ID and password combination is lost, stolen, or otherwise misappropriated, the person in possession of that note can impersonate the user and access the user's protected computers and sites at will. The vault approach, although much more secure, is not faultless either. If the vault runs on a computer compromised by malware, authenticating data can be intercepted either while it is being written into the vault or read out of it. Moreover, an unencrypted network traffic can be easily scanned, and the user authenticating data, as well as the vault's master password, could still end up in the wrong hands.

To address the foregoing deficiencies, some software vendors offer their subscribers automated password generating mechanisms, in which a password is generated and relayed to the user in response to the user providing some required identification information. Even though this approach greatly increases the level of security, it still is incapable of fully protecting against intruders. It also is extremely inconvenient to the user since inadvertent typos in a computer-generated password may lead to lock-outs (like, for example, typing “mAWL0xD57uLfJsNDhlZ7” instead of mAWL0sD57uLfJsNDhlZ7), which is of a particular concern in cases where server lacks password recovery mechanisms.

In cases where the user must choose her own user ID, a situation may occur where the user ID selected by the user already belongs to someone else. In some other cases, the user may be required to rely on her own e-mail address as her user ID. Even though the latter simplifies the task of password recovery and eliminates any possibility of the user ID being not unique, it, nonetheless, increases the possibility of identity theft and may lead to spams. Yet in some other cases, the user may not be required to setup her password at all. Instead, the user selects her email address as the user ID, and a system-generated password is then sent to that email address. However, even this generally safe approach is not completely bulletproof as the automatically generated password sent by e-mail can be intercepted by scanning an unsecured network, or acquired by someone having access to the recipient's email account.

In addition, the mere process of transferring authenticating data from client computer to protected remote server is inherently unsafe in situations where the user logs onto the remote site from client of questionable security, such as, for example, a work computer where the user's activity is monitored by the employer, or a public computer, such as a computer installed at a public library, where cached authenticating data may be obtained by an unauthorized “next” user.

There are many mechanisms exist that can be used for intercepting authenticating data even without a need to hack into client or server. Anyone with access to the communication channels between client and the remote site can position herself in those channels as a so-called “intruder in the middle”, or gather authenticating data through open wireless access points, or from popular resources such as, for example, Tor network.

The foregoing “intruder in the middle” attacks can easily circumvent even such secure authenticating mechanisms as OpenID®, which is a decentralized protocol for allowing users to be authenticated by certain co-operating sites using a third-party service. The circumvention is pretty simple and inexpensive: the “intruder in the middle” offers a user to log onto a “fake” remote site that looks identically to the protected site the user is intending to connect to, and then captures authenticating data as the user enters it.

Thus, for as long as authenticating data is being transmitted between unsecured client computers and protected sites via unsecured networks, it is impossible to guarantee that authenticating data will not be misappropriated by hackers, computer fraudsters and various criminals operating over the Internet. Logically, one approach to overcoming the foregoing deficiencies may be based on making sure that authenticating data is always transmitted from a secured client via an equally secured network to an equally secured server. However, with the continuing popularity of network computing, this appear to be rather impossible. The present invention discloses such a solution based on the algorithm of delegating the task of transmitting authenticating data to a protected remote site via a tightly controlled and secured network to a secured authenticating client (“authenticating manager”).

The present invention is premised on allowing a secured authentication manager to transmit authenticating data to a protected remote computer while impersonating an unsecured client computer. The impersonation is achieved by allowing the authentication manager to use client-server session ID (hereinafter “SID”) and the server's identity information (“SIP”) provided to the authentication manager by the unsecured client.

Even though there still a possibility that SID and SIP communicated by the unsecured client to the authentication manager could be intercepted by an intruder, the intruder's access to that specific session data is far less dangerous and consequential than her access to authenticating data.

Although the present invention is novel, unique and original, there are solutions exist that are based on a similar concept. For example, a popular WhatsApp® application allows a user to associate her network session established via a computer's browser with a network session establish via a smartphone by allowing the smartphone to scan the QR code displayed in the browser. Although this conceptually is somewhat similar to the session data “borrowing” mechanism disclosed by the present invention, it does not provide for user authentication or registration.

Another somewhat similar solution is provided by Android™ OS allowing to established a secured communication link between the user's Android™-based smartphone and the user's computer by scanning a unique QR displayed by the computer with the smartphone. Again, although built on a similar concept, unlike the present invention, this solution approach offers no solution to the foregoing deficiencies related to the user's authentication and registration.

### SUMMARY OF THE INVENTION

The present invention describes a system and method for the user's authentication and registration using a third-party secured computing device capable of impersonating an unsecured client computer. It is designed to significantly improve the safety of the network computing by eliminating a need for transmitting users' sensitive authenticating data from an unsecured client to a protected remote server via unsecured networks.

A protected server communicates with a remote client by way of establishing and maintaining a communication channel called “session”. Any such session is represented by a data structure (“session data”) comprising attributes used by server for identifying client communicating with it.

The session data containing client's identity attributes allows server to identify a requesting client and respond to that client's requests by sending reply communications. Even if the client sends multiple requests, client's identity attributes contained in the session are the same, which enables server to trace all those requests to the very client sending them, and reply to that client only.

One of the simplest and most commonly used implementations of session data is a so-called TCP/IP socket, which is defined as an endpoint of an inter-process communication across a computer network. By analyzing TCP/IP socket's content, particularly, the client's address and the port, the server is able to identify communicating client and send its responses to that client only.

A more complex implementation of the session data is based on a so-called WEB service request. The HTTP protocol, which is the standard behind WEB service requests, is based on the following sequence: a) client sends connect request to server; b) server responds by establishing connection to client; and c) connection termination. Due to HTTP protocol's limitation, server is incapable of identifying the exact client that sent the connect request. In order to enable server to identify that specific client, each session between server and client is assigned a unique session ID, which is usually represented by a “cookie” file sent from server to client. By transmitting that “cookie” back and forth with each and every request and response, both client and server know the identity of each other, and, thus, are capable of communicating directly.

If we find a way to allow some other client computer to “borrow” SID of the already established client-server session, that other computer would be able to impersonate the original client so server would “think” that the information sent to it by that other computer was indeed sent by the original client. By using this approach not only can we engage that other computer into trivial data exchange between itself and server, but, providing the other computer is secured, we can also use it to send to server user's authenticating data instead of the original unsecured client.

The following is the gist of the present invention: the unsecured client shares with a third-party secured computer the identity of the server it has established a session with, SIP, that session's session ID, SID. The third-party secured computer establishes its own secured session with the remote computer such that the remote computer is led to believe that it is communicating with the original client. Once the connection is established, the secured third-party computer, acting as the authentication manager, safely sends the original client's authenticating data to the server. Once the authentication or registration is performed, the server resumes its normal communications with the original unsecured client.

By way of illustration, the following is an exemplary embodiment of the present invention. User P logs onto Client A and connects to Server X using SIP; a network session is established. Server X assigns to that session unique SID, and provides SID and SIP to Client A. Client A shares SID and SIP with a secured Client B. Client B, using SID and SIP, and having either User P authenticating data or her registration information, connects to Server X via a secured network, and provides Server X with User P authenticating data or registration information. Once User P is authenticated, Server X resumes its normal communications with already authenticated unsecured Client A.

### BRIEF DESCRIPTION OF THE DRAWINGS

These and other features of this invention will be more readily understood from the following detailed description of the various aspects of the invention taken in conjunction with the accompanying drawings.

FIG. 1 shows traditional network user's authentication or registration without third-party authentication manager;

FIG. 2 depicts “intruder in the middle” scenario;

FIG. 3 depicts OpenID® “intruder in the middle” scenario;

FIG. 4A shows initial communication requests between client and server;

FIG. 4B shows third-party authentication manager-based authenticating mechanism;

FIG. 5 shows “one client to plurality of servers” scenario;

FIG. 6A depicts client-authentication manager impersonation based on manual entry;

FIG. 6B depicts client-authentication manager impersonation based on URI; and

FIG. 6C depicts client-authentication manager impersonation based on barcode-type image;

FIG. 6D depicts client-authentication manager impersonation without user's participation; and

FIG. 7 shows authentication of user certificate by certificate manager.

### DETAILED DESCRIPTION OF THE INVENTION

The following is a detailed description of the invention provided to aid those skilled in the art in practicing in the field of the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

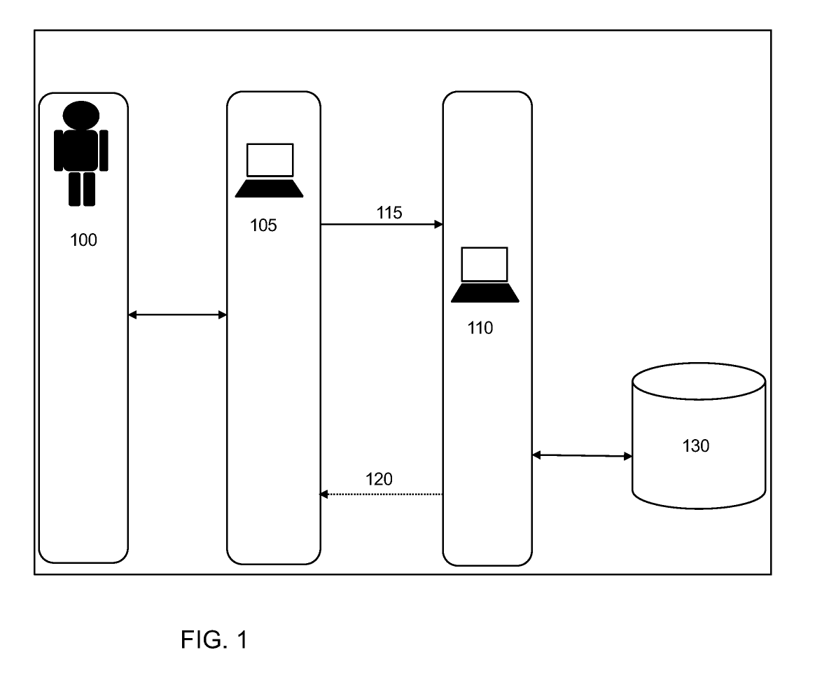

Referring to FIG. 1, a new user's registration is based on the following chain of events. User 100 passes user ID and password she chooses, 115, to server 110, which then checks user ID against user's registry 130 and password/user ID combination for compliance with an existing security policy. If the match is found or password/user ID combination is determined to be incompliant with the security policy, user 100 is not permitted to register. If the match is not found and password/user ID is compliant with the security policy, user's credentials are recorded into user's registry, 130. In either situation, server 110 passes status of registration 120 back to client 105 and then to user 100. In some cases, the foregoing registration can be done by server administrator who, in a likewise manner, records user's unique combination of user ID and password into user's registry 130.

Once the user is registered, she can get access to server's protected resources by passing user ID/password combination, 115, from client 105 to server 110, which then compares user ID/password combination 115 against users' registry 130. If the match is found, user 100 is permitted to log onto server 110, but if the match is not found, user's logging attempt is rejected. In either situation, server 110 passes status of authentication 120 back to client 105 and then to user 100. Thus, if client 105 or the network between client and server 110 are unsecure, password/user ID 115 can be intercepted.

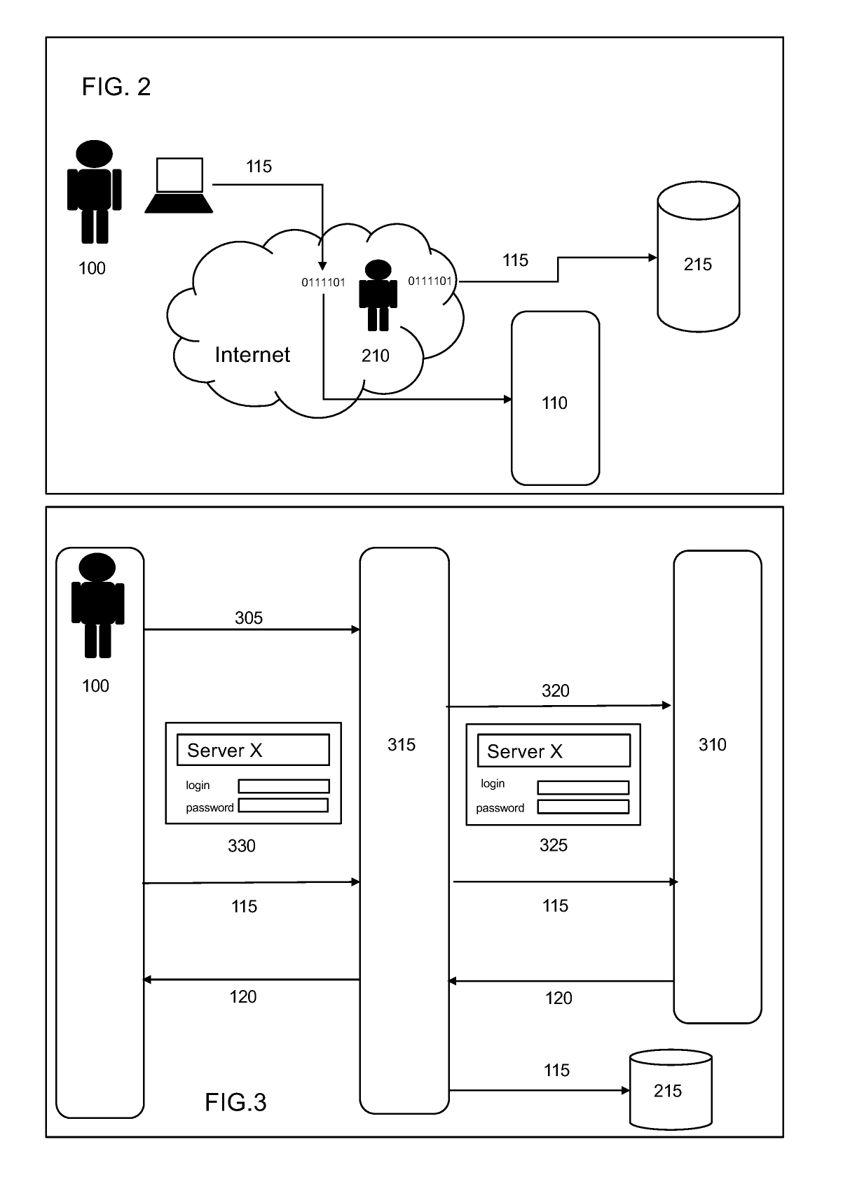

Referring now to FIG. 2, intruder 210 with access to communication channels between client 105 and server 110 can position herself in those channels as a so-called “intruder in the middle”, or “intruder”. Once there, intruder 210 can intercept password/user ID 115 sent by user 100 to server 110, and then redirect it to target 215 of intruder's choice.

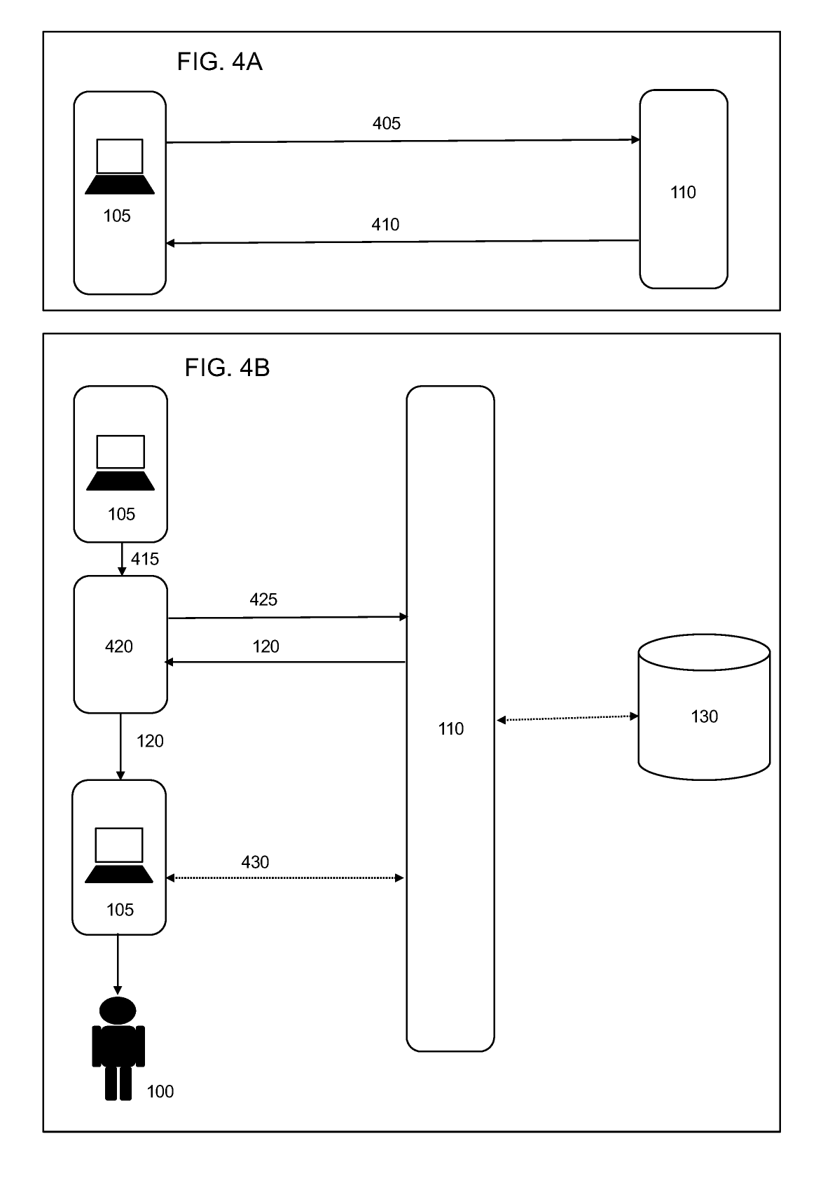

The foregoing “intruder in the middle” attack can easily circumvent even such secure authenticating mechanism as OpenID®. The circumvention is pretty simple and inexpensive as shown in FIG. 3. User 100 transmits her connect request 305 to OpenID® authentication server 310. Intruder's server 315 intercepts that request and transmits its own request 320 mimicking original request 305. Authentication server 310 responds with login page 325, which intruder's server 315 intercepts and sends its own fake copy 330 back to user 100. User 100 enters her password/user ID 115 into fake login page 330, and unknowingly sends it to intruder's server 315 instead of authentication server 310. Intruder's server 315 passes password/user ID 115 to both authentication server 310 and her own device 215. Once that information is received, authentication server 310 authenticates user 100 and transmits, albeit unintentionally, authentication status information 120 to intruder's server 315, which then passes it to user 100. As a result, password/user ID 115 is misappropriated, yet neither user 100 nor authentication server 310 are aware of the breach.

To address the foregoing, the present invention is directed at a system and method for computer users' authentication and user registration via a secured third-party computing device capable of impersonating an unsecured client and communicating with a protected remote server via a secured network.

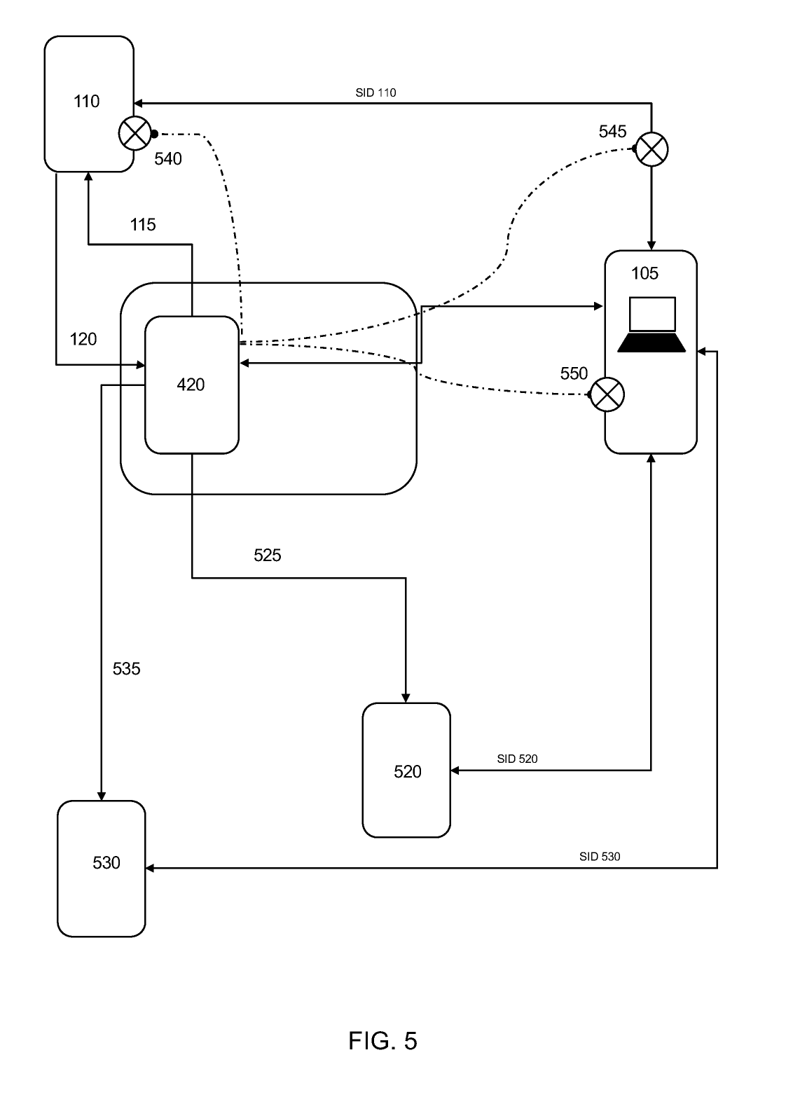

The present invention is based on a seven-step approach described herewith:
STEP 1 Referring to FIG. 4A, unsecured client 105 establishes network session with server 110 using SIP, 405;
STEP 2 Server 110 generates SID 410 assigned to that session and transmits it back to client 105;
STEP 3 Now referring to FIG. 4B, client 105 transmits SID/SIP combination 415 to authentication manager 420;
STEP 4 Authentication manager 420 establishes connection to server 110 using SIP extracted from combination 415, and passes to server credentials 425 comprising SID 410 and password/user ID 115;
STEP 5 Server 110 recognizes SID 410 and, presuming it communicates with client 105, authenticates user 100 against registry 130;
STEP 6 Once user 100 is authenticated, server 110 passes authentication status 120 to authentication manager 420, which, in turn, passes it to client 105; and
STEP 7 Once client 105 receives authentication status 120, it continues normal data exchange 430 with server 110.

In some embodiments, the foregoing registration is performed by authenticating manager generating and supplying server with a compliant user ID/password combination.

In some embodiments, server may request authenticating manager to perform some additional steps directed at client, such as account activation, mass-registration prevention, setting up user's profile, among others.

In other exemplary embodiments, server 110 may inform client 105 that user 100 she has been successfully authenticated prior to the user continuing her attempts to communicate with server 110 from client 105.

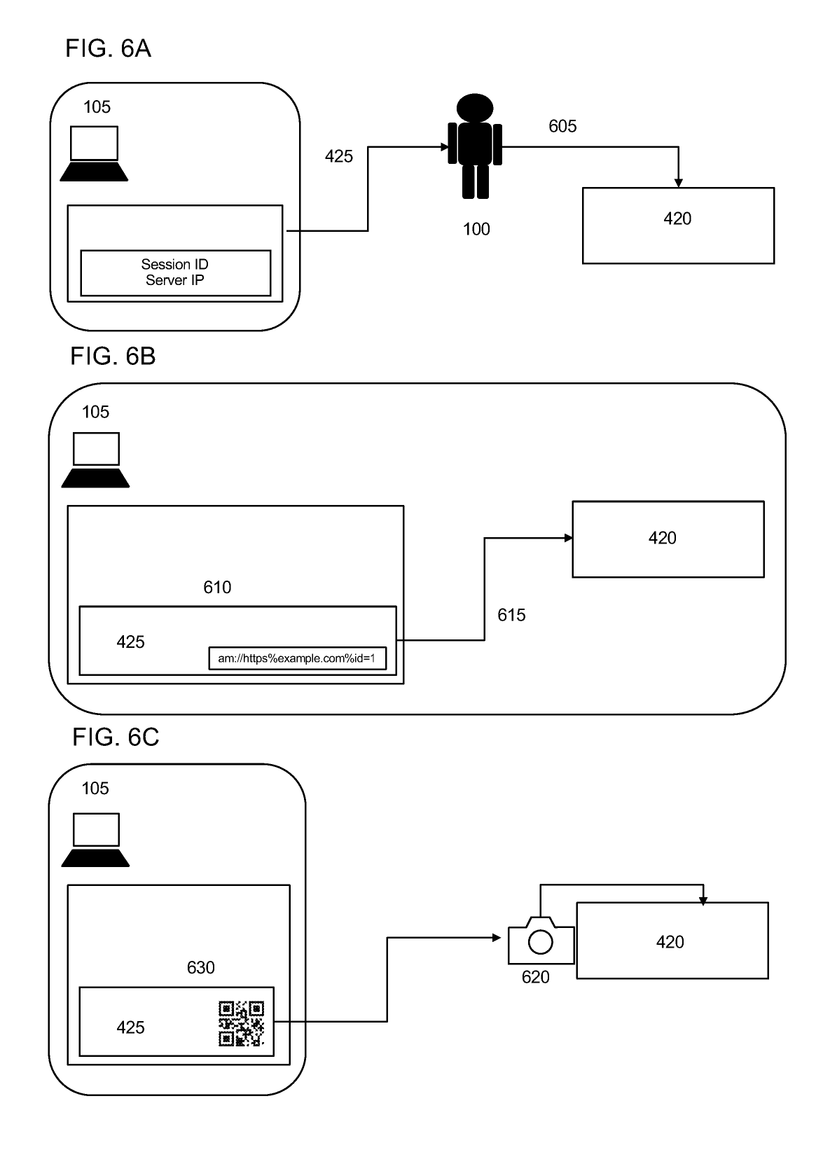

Referring back to STEP 4 and FIG. 5, in some embodiments of the present invention, authentication manager 420 may be programmed to generate and use, for a given user, different combinations of user IDs and passwords for different servers, 110, 520, and 530 respectively. This affords a high level of anonymity since it would be impossible to link that given user to different servers since her user IDs are different. By way of illustration, if user 100 has accounts on a plurality of servers 110, 520 and 530, user's sets of credentials for each of the servers, 115, 525 and 535 respectively may be different, and, thus, it would be virtually impossible to trace user 100 to servers 110, 520 and 530 as and identify her as being the same user.

On the other hand, the foregoing situation opens the door to automatic mass registrations as it is impossible to identify the exact user behind different user IDs on different servers. This, of course, can be prevented by utilizing some kind of an activation requirement, such as, for example, sending a link via e-mail to the user and requesting confirmation, but this would necessarily lead to forfeiting the aforementioned benefit of anonymity.

As indicated, in some embodiments, STEP 4 authentication may be performed by generating and supplying user ID/password combination. This requires storing matching combinations on server, which creates an additional possibility for credentials to be compromised. To prevent this, in some exemplary embodiments, the present invention may utilize a unique user certificate generated by the authenticating manager, which can then be used either instead or together with user ID/password combination.

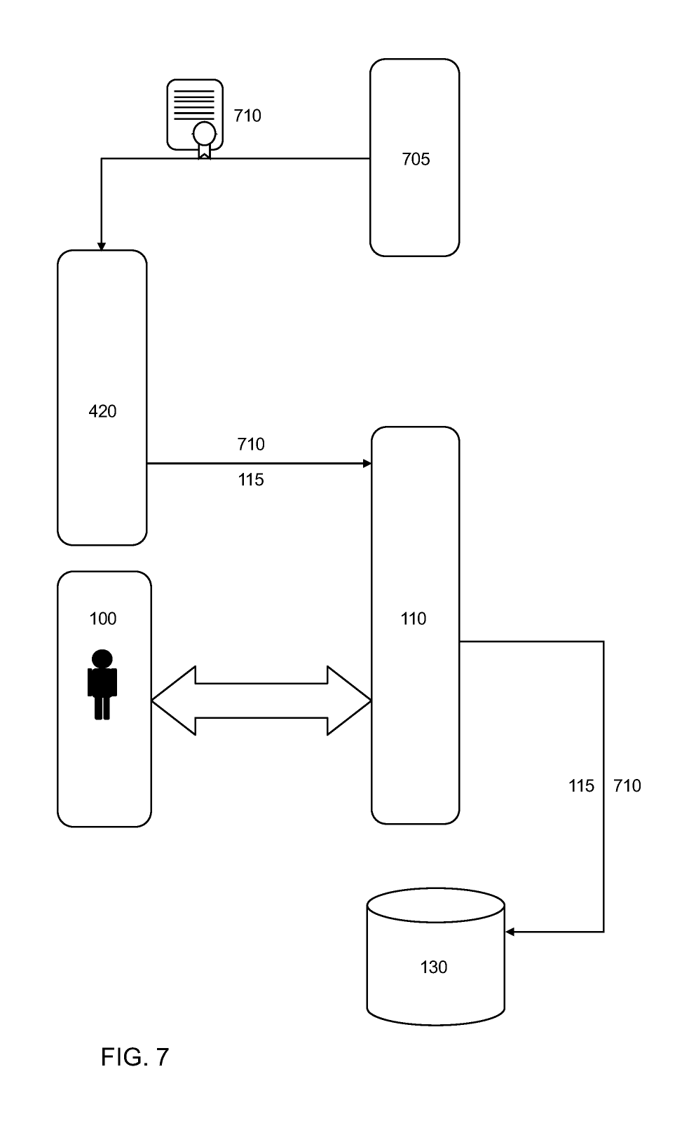

The foregoing user certificate may belong to different classes, depending on behavioral designations of those classes. For example, and now referring to FIG. 7, certificate 710 may be validated by certification manager 705 in case of a free certificate, where server 110 may require authenticating manager 420 to perform client activation steps. These steps may not be needed in case of a paid-for certificate.

It is possible to use certain “pay-for” certificate classes to prevent user IDs from being “linked” to the user's login credentials on different servers. Let's assume authentication manager provides user with several certificates that are to be used for activating user's registrations on a plurality of servers. In this case, linking user IDs to the identity of the user is a complicated process, as it requires no only linking user IDs on different servers, but linking them to certification manager that issued said certificates. As for authentication manager, it does not control the use of certificates, and, thus, is unable to control on which server a given certificate is to be used.

In this particular embodiment of the present invention, STEP 4 above may be enhanced by tasking authentication manager with transmitting certificate to server, and confirming that server is in possession of the private key associated with that certificate. Referring now to FIG. 7, certification manager 705 issues certificate 710, which could be free or “pay for”, and transmits it to authentication manager 420, which then transmits the combination of user ID/password 115 and/or certificate 710 to server 110 for registering in registry 130.

In some embodiments, authentication manager may reside on the same computing device as client. In this case, user's information in possession of the authentication manager is subject to leakage if the computing device is compromised or attacked. If the device is compromised in terms of its cache or IO interface, the information will still be protected as the authentication manager uses neither cache nor IO interface for accessing authentication data.

Referring now back to STEP 4, in some embodiments of the present invention, transfer of SID/SIP combination to authentication manager may be performed in several ways, including, but not limited to: a) entering information manually; b) using Uniform Resource Identifier, or URI, with encrypted SID/SIP and the operating system means for transferring said URI to application manager; c) using machine-generated image, such as a barcode, containing SID/SIP; or d) automatically via a software program.

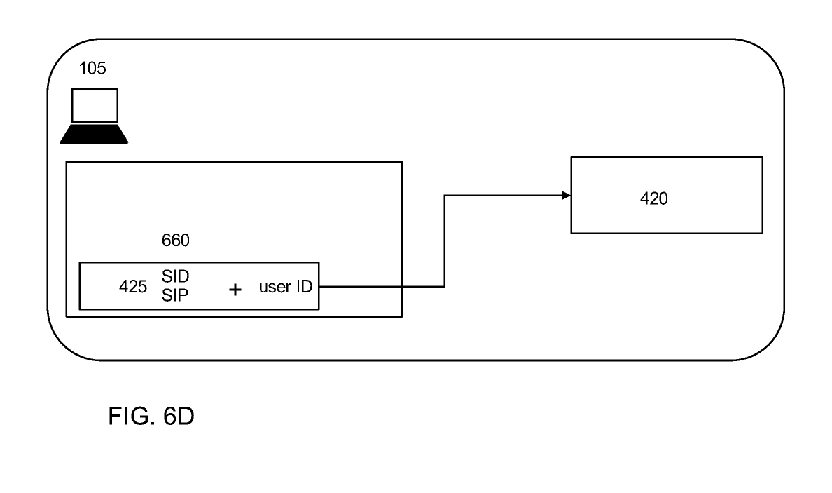

In the scenario where SID and SIP address are entered manually, FIG. 6A, user 100 fetches SID and SIP information 425 from client 105, and enters it manually 605 into authenticating manager 420.

In the URI-based scenario, FIG. 6B, authentication manager derives authentication information from the URI passed to it by client. In this variation of the present invention, server (not shown) transmits client 105 link 610 referencing URI and containing encrypted SID and SIP. User activates link 610, client 105 transmits link 610 to authentication manager 420, which then fetches SID and SIP from link 610, and the process continues according to STEP 4.

In the machine-generated image scenario, FIG. 6C, SIP and SID are encrypted into a barcode that can be selected from 1D barcodes, such as EAN-13, EAN-8, UPC-A, UPC-E, Code128, ITF, Code39, GS1, and DataBar™, or 2D codes, such as QR code. This is a preferable approach in configurations where client 105 and authentication manager 420 run on different computing devices, and authentication manager is equipped with means for reading barcodes, such as barcode scanners or cameras. In this variation of the present invention, authentication manager 420 can be a mobile device, such as a smartphone, a tablet computer, or the like, equipped with means for reading barcodes 620. Upon receiving session request from client 105, server (not shown) generates barcode comprising SID and SIP, and transmits this barcode back to client 105. In some embodiments, client 105 may itself generate barcode based on SID and SIP received from server. Once barcode 630 is either received or generated by client 105, it displays barcode 630, user (not shown) scans it by barcode reading means 620 into authentication manager 420, which then extracts SID and SIP, and continues processing according to STEP 4. In this embodiment, user authenticating information is well protected and cannot be easily compromised.

In other embodiments, the interaction between client and authentication manager may be implemented without user's participation. Referring now to FIG. 6D, user (not shown) enters her user ID onto client 105, which “knows” the identity of authentication manager 420 and means for communicating with it, such as LAN, WAN, Bluetooth, NFC, and others. Once client 105 receives SID from server, software program 660 triggers transmission of SID, SIP 425 and user ID to authentication manager 420, which then looks up and fetches that user ID's authenticating record for SIP, establishes connection to server using supplied SID and SIP, and authenticates user by transmitting previously fetched authenticating record to server. Once user is authenticated, authentication manager 420 passes control back to client 105.

In some embodiments of the present invention, the interaction between authentication manager and server includes additional steps, such as information exchange about active sessions, time of occurrence of certain events, such as the last activity of a given session and the sessions' idle time, as well as processing requests directed at sessions' terminations. The latter will allow terminating a compromised session even with “intruder in the middle” scenario, which otherwise could remain in control of the session even after the client's exit. To illustrate this embodiment, we are referring back to FIG. 5.

In the “intruder in the middle” scenario, however, if authentication manager 420 becomes aware that client 105 is compromised, it terminates session SID110 545 between compromised client 105 and server 110, blocks server 110 from accepting further connection requests 540, and blocks client 105 from initiating further connection requests 550.

Yet in other embodiments, the foregoing method of authentication may be commenced by user via authentication manager. In this scenario, user passes to authentication manager either her user ID, if authentication manager maintains user repository, or user ID/password combination, if it does not. In the former scenario, authentication manager looks up authenticating record using the supplied user ID, and transmits fetched authenticating record to server. Once user is authenticated, authentication manager relays session's SID to client, and client begins its communication with server according to STEP 7. The foregoing transmittal of SID from authentication manager to client may be executed via a software program, manually, via URI, by a barcode, or by any other means known in the art.

Method embodiments described herein are computer-implemented. Some embodiments include computer-readable media encoded with a computer program (e.g. software), which includes instruction operable to cause an electronic device such as a computer or computer network to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but not limited to, hard disks, removable magnetic disks, removable optical disks (e.g. computer disks and digital video disks), memory cards or sticks, random access memories (RAM), read only memories (ROM), and the like.

It should be appreciated from the forgoing that the invention described herein offers a method, a system, and a computer-implemented algorithm for managing and coordinating various client-related events. The resulting solution improves the overall process of on-boarding new clients and products, making changes to the existing clients and products, and managing the lifecycle of any project involving more than one department in the firm.

The description of the present embodiment has been presented for purposes of illustration, but is not intended to be exhaustive or to limit the invention to the form disclosed. Many modifications and variations will be apparent to those of ordinary skill in the art. For example, the processes of the present invention are capable of being distributed in the form of a computer readable medium of instructions. Such computer readable medium may have a variety of forms. The present invention applies equally regardless of the particular type of signal bearing media actually used to carry out the distribution. Examples of tangible computer readable media include recordable-type media such a flush drive, a hard disk drive, a RAM, and CD-ROMs. Examples of transmission-type media include digital and analog communications links.

Various embodiments implement the one or more software programs in various ways, including procedure-based techniques, component-based techniques, and/or object-oriented techniques, among others. Specific examples include C#, .NET and commercial class libraries. Those of ordinary skill in the art will appreciate that the hardware depicted herein may vary depending on the implementation. The depicted example is not meant to imply architectural limitations with respect to the present invention.

The terms “logic,” “model” and “memory” may have been used herein. While the logic and model referred to herein have generally be described in terms of instructions, data structures and computer processes, it should be understood that these terms may alternatively refer to circuitry that is part of the design for an integrated circuit chip.

Herein above, or in the following claims, the term “comprises” is synonymous with “includes.” The use of terminology such as “X comprises A, B and C” is not intended to imply that A, B and C are necessarily the only components or most important components of X.

Unless clearly and explicitly stated, the claims that follow are not intended to imply any particular sequence of actions. The inclusion of labels, such as a), b), c) or 1), 2), 3) etc., for portions of the claims does not, by itself, imply any particular sequence, but rather is merely to facilitate reference to the portions.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention.

We claim:

1. A method for user's registration using a third-party network computing device comprising:
receiving, by a process running on a client computer, said user's request to establish a first network connection from said client computer to a server computer identified by said server computer's address;
establishing said first network connection between said client computer and said server computer;
determining, by a process running on said server computer, a session ID of said first network connection;
establishing a second network connection between said third-party network computing device and said server computer using said address;
receiving, by a process running on said third-party computing device, said user's authenticating record comprising a user ID and a password.
transmitting said user's authenticating record from said third-party networked computing device to said server computer using said second network connection and said session ID;
registering, by a process running on said server computer, said authenticating record of said user;
transmitting a status of said user registration from said server computer to said third-party computing device;
terminating said second network connection and transmitting said status of said user registration from said third-party computing device to said client computer; and
continuing said first network connection between said client computer and said server computer.

2. The method according to claim 1 where said relaying of said session ID and said address to said third-party computing device is done manually by said user.

3. The method according to claim 1 where said relaying of said session ID and said address to said third-party computing device is done via a URI.

4. The method according to claim 1 where said relaying of said session ID and said address to said third-party computing device is done via a barcode.

5. The method according to claim 1 where said relaying of said session ID and said address to said third-party computing device is done by a software program running on said client computer and a software program running on said third-party computing device via a third network connection between said client computer and said third-party computing

6. A method for user's authentication using a third-party network computing device comprising:
receiving, by a process running on a client computer, said user's request to establish a first network connection from said client computer to a server computer identified by said server computer's address;
establishing said first network connection between said client computer and said server computer;
determining, by a process running on said client computer, a session ID of said first network connection;
establishing a second network connection between said third-party network computing device and said server computer using said session ID and said address;
receiving, by a process running on said third-party computing device, said user's authenticating record comprising a user ID and a password.
transmitting said user's authenticating record from said third-party networked computing device to said server computer using said second network connection;
authenticating, by a process running on said server computer, said user using said authenticating record;
transmitting a status of said user authentication from said server computer to said third-party computing device;
terminating said second network connection and transmitting said status of said user authentication from said third-party computing device to said client computer; and
resuming said first network connection between said client computer and said server computer.

7. The method according to claim 6 where said relaying of said session ID and said address to said third-party computing device is done manually by said user.

8. The method according to claim 6 where said relaying of said session ID and said address to said third-party computing device is done via a URI.

9. The method according to claim 6 where said relaying of said session ID and said address to said third-party computing device is done via a barcode.

10. The method according to claim 6 where said relaying of said session ID and said address to said third-party computing device is done by a software program running on said client computer and a software program running on said third-party computing device via a third network connection between said client computer and said third-party computing device.

11. A system for user's registration and authentication using a third-party network computing device comprising:
a client computer;
a server computer;
a third-party network computing device;
a first computer network between said client computer and said server computer;
a second computer network between said third-party network computing device and said server computer;
a storage device connected to said client computer, wherein said storage device has stored thereon a first software program, and wherein said client computer is operative with said first software program to execute said first software program for requesting a first network connection via said first computer network using said server computer's address, and determining said first network connection's session ID once said first network connection is established, and wherein said a storage device connected to said third-party network computing device, wherein said storage device has stored thereon a second software program, and wherein said third-party network computing device is operative with said second software program to execute said second software program for receiving said server computer's address and said first network connection's session ID, and requesting a second network connection via said second computer network using said server computer's address and said first network connection's session ID, and wherein said third-party network computing device is operative with said second software program to execute said second software program for receiving said user's authenticating record comprising a user ID and a password, and transmitting said authenticating record to said server computer via said second network connection once said second network connection is established; and
a storage device connected to said server computer, wherein said storage device has stored thereon a third software program, and wherein said server computer is operative with said third software program to execute said third software program for establishing said first network connection and said second network connection, and wherein said server computer is operative with said third software program to execute said third software program for receiving said authenticating record via said second network connection, and wherein said server computer is operative with said third software program to execute said third software program for registering or authenticating said user using said authenticating record.

12. The system according to claim 11 wherein said client computer is operative with said first software program to execute said first software program for generating URI comprising said server computer's address and said first network connection's session ID, and wherein said third-party network computing device is operative with said second software program to execute said second software program for receiving said URI.

13. The system according to claim 11 wherein said client computer is operative with said first software program to execute said first software program for generating a barcode comprising said server computer's address and said first network connection's session ID, and wherein said third-party network computing device is operative with said second software program to execute said second software program for receiving said barcode.

14. The system according to claim 11 further comprising a third computer network between said client computer and said third-party computing device.

15. The system according to claim 14 wherein said client computer is operative with said first software program to execute said first software program for transmitting said user ID, said address and said first network connection session ID to said third-party computing device via said third computer network, and wherein said third-party computing device is operative with said second software program to execute said second software program for determining said authenticating record based on said user ID.
